(19) United States
(12) Patent Application Publication
(10) Pub. No.: US 2005/0129964 A1
(43) Pub. Date: Jun. 16, 2005

(54) Plane metal component

(76) Inventor: Gerd Hugo, Schondorf (DE)

Correspondence Address: NATH & ASSOCIATES, 1030 15th STREET, NW, 6TH FLOOR, WASHINGTON, DC, 20005, US

(21) Appl. No.: 10/503,624

(22) PCT Filed: Jan. 28, 2003
(86) PCT No.: PCT/DE03/00222

(30) Foreign Application Priority Data
Feb. 6, 2002 (DE) 102 04 829.0

(51) Int. Cl. B32B 15/08; B32B 5/16

(52) U.S. Cl. 428/458; 428/330; 428/329; 428/331; 428/327; 428/461; 428/463; 428/472.2

(57) ABSTRACT

The invention relates to a plane metal component, the outer surface thereof being coated such that it reflects sunlight in the near-infrared region, and the inner surface thereof having low thermal emissivity.

### TECHNICAL FIELD

The invention relates to a plane metal component, ie flat metal structural element, with an external surface exposed to the sunlight that, even with a dark colouring reflects more sunlight than conventional colourings and an inner surface with low emissivity in the thermal radiation wavelength range. A flat structural element of this kind is used as a roof or wall element in particular in cattle sheds or warehouses, which generally have no additional thermal insulation. The lower solar absorption of the outer coating and the low emissivity of the inner coating cause less heat to be transported into the interior and hence a better internal climate is established. In winter, the interior low-emission coating reflects part of the heat generated in the interior back into the interior.

### PRIOR ART

Usually, the sheet roofing and wall components of agricultural buildings, such as cattle stalls or warehouses are dark-coloured. For example, in the United States of America, where cattle stalls and stables made of steel sheet elements are very common, particularly in the south, the roofs are generally coloured brick-red, blue, green and grey.

Although, in view of solar absorption it would be much more beneficial for the buildings to be coloured white at least initially, people do not like this since everyone knows that white soon becomes grey as a result of soiling. In addition, military tool sheds and warehouses also have to be in dark colours for camouflage reasons.

Dark colours are extremely disadvantageous with cattle stalls. In summer, the animals have to be cooled by ventilators and sometimes even with sprinkler systems. In winter, it can be extremely cold even in states as far south as Texas. Obviously, the insulation of the buildings would be a good solution, but it would be very expensive as these buildings are generally very large.

DE 198 49 330 discloses a thermal insulating sheet that may be used, for example, as a sunblind. This thermal insulating element also has one side that reflects solar radiation and one side with low emissivity. Here, the drawback is that the coatings described cannot be used on metal, since the metal would become corroded after too short a time. A further disadvantage is the fact that the side reflective to solar radiation contains titanium dioxide. However, since titanium dioxide has a strong absorption band in the UV range, up to 15% of the solar energy is absorbed in this wavelength region.

The objective of the present invention is to provide flat metal structural elements with external colours that appeal to the users' aesthetic sensitivities, or, in the case of military objects blend into the colours of the ambient landscape, but which, notwithstanding their darker coloration, absorb less sunlight than conventional colours. Another objective of this invention is to design the interior of the flat structural elements so that they radiate less heat into the interior areas and at night or in winter reflect back some of the heat generated in these interior areas. According to the invention, this is achieved by a flat metal structural element with the following features:
a. its first, outer surface is provided with a first coating that protects the metal from corrosion and on average reflects 60% of sunlight in the 320 to 1200 nm wavelength region
b. its first, outer surface is provided with a second coating, which has a reflection of on average less than 60% in the visible light wavelength region of 400 to 700 nm and has a reflection of on average more than 60% in the near infrared wavelength region of 700 to 1200 nm
c. its second, inner surface is provided with a first coating, which protects the metal from corrosion
d. its second, inner surface is provided with a second coating, which has low emissivity and an emissivity of less than 0.75 in the thermal infrared wavelength region of 5 to 25 μm.

Advantageous further embodiments of the inventive idea are revealed by the subclaims. One advantageous further embodiment of the inventive idea results from the fact that the first coating on the first outer surface reflects on average 70% of sunlight in the wavelength region of 320 to 1200 nm.

One advantageous further embodiment of the inventive idea results from the fact that the second coating of the first, outer surface has on average a reflection of less than 50% in the wavelength region of visible light of 400 to 700 nm.

One advantageous further embodiment of the inventive idea results from the fact that the second coating on the first, outer surface has on average a reflection of more than 70% in the near infrared wavelength region of 700 to 1200 nm.

A further advantageous further embodiment of the inventive idea results from the fact that the second coating of the second, inner surface has an emissivity of less than 0.65 in the wavelength region of 5 to 25 μm.

In a further advantageous further embodiment of the inventive idea, the binder in the coatings is selected from the group of solvent-based binders comprising acrylates, styrene acrylates, polyvinyls, polystyrenes and styrene copolymers, alkyd resins, saturated and unsaturated polyesters, hydroxyfunctional polyesters, melamine-formaldehyde resins, polyisocyanate resins, polyurethanes, epoxy resins, fluoropolymers and silicones, chlorosulfonated polyethylene, fluorinated polymers, fluorinated acryl copolymer, fluorosilicones, plastisols, PVDF and mixtures thereof, selected from the group of aqueous binders comprising the group of water-soluble binders comprising alkyds, polyesters, polyacrylates, epoxides and epoxide esters, from the group of aqueous dispersions and emulsions comprising dispersions and emulsions based on acrylate, styrene acrylate, ethylene acrylic acid copolymers, methacrylate, vinyl pyrrolidone vinyl acetate copolymers, polyvinyl pyrrolidone, polyisopropyl acrylate, polyurethanes, silicone, wax dispersions based on polyethylene, polypropylene, Teflon®, synthetic waxes, fluorinated polymers, fluorinated acryl copolymer in aqueous solution, fluorosilicones and mixtures thereof.

An advantageous further embodiment of the inventive idea results from the fact that selected for the first coating on the first, outer surface are anticorrosion pigments that are transparent in the solar wavelength region of 400 to 1200 nm and have a particle size selected so that on average they have a backscatter of more than 60% in the solar wavelength region of 320 to 1200 nm.

One advantageous further embodiment of the inventive idea results from the fact that the anticorrosion pigments are selected from the group of white anticorrosion pigments, in particular selected from calcium-zinc molybdate compounds selected from strontium zinc phosphorosilicate compounds.

One advantageous further embodiment of the inventive idea results from the fact that the particle size of the white anticorrosion pigments is between 1 and 3 μm.

Another advantageous further embodiment of the inventive idea results from the fact that first white pigments and fillers for the first coating on the first, outer surface are selected from the group of inorganic white pigments and fillers, selected from the group of metal oxides, in particular zirconium oxide, selected from the group of metal sulfates, metal sulfides, metal fluorides, metal silicates, metal carbonates and mixtures thereof.

One advantageous further embodiment of the inventive idea results from the fact that the first white pigments and fillers are selected from the group of degradable materials, selected from calcium carbonate, magnesium carbonate, zirconium silicate, aluminium oxide, barium sulfate and mixtures thereof.

One advantageous further embodiment of the inventive idea results from the fact that first coloured pigments for the second coating on the first, outer surface are selected from the group of organic pigments, which absorb spectrally selectively in the visible light wavelength region of 400 to 700 nm and have on average a transmission of more than 60% in the near infrared wavelength region of 700 to 1200 nm.

One advantageous further embodiment of the inventive idea results from the fact that the first coloured pigments have on average a transmission of more than 70% in the near infrared wavelength region of 700 to 1200 nm.

One advantageous further embodiment of the inventive idea results from the fact that the first coloured pigments are selected from the group of azo pigments, selected from monoazo, bis-azo, β-naphthol, naphthol AS, lacquer-formed azo, benzimidazolone, bis-azo condensation, metal complex, isoindolinone and isoindoline pigments, selected from the group of polycyclic pigments, selected from phthalocyanine, quinacridone, perylene and perinone, thioindigo, anthraquinone, anthrapyrimidine, flavanthrone, pyranthrone, anthanthrone, dioxazine, triarylcarbonium, quinophthalone and diketo-pyrrolopyrrole pigments.

A further advantageous further embodiment of the inventive idea results from the fact that second coloured pigments for the second coating on the first, outer surface are selected from the group of organic pigments that absorb spectrally selectively in the visible light wavelength spectrum of 400 to 700 nm and have on average a reflection of more than 50% in the near infrared wavelength region of 700 to 1200 nm.

One advantageous further embodiment of the inventive idea results from the fact that the second inorganic coloured pigments have on average a reflection of more than 60% in the near infrared wavelength region of 700 to 1200 nm.

One advantageous further embodiment of the inventive idea results from the fact that the second inorganic coloured pigments are selected from the group of metal oxides and hydroxides, in particular iron oxides, from cadmium, bismuth, chromium, ultramarine blue and iron-blue pigments, from the group of mixed phase rutile and spinel pigments and coated, platelet-shaped mica pigments.

One advantageous further embodiment of the inventive idea results from the fact that selected for the second coating on the second, inner surface are platelet-shaped metal pigments that have on average a reflection of 60% in the thermal infrared wavelength region of 3 to 50 μm.

Another advantageous further embodiment of the inventive idea results from the fact that the platelet-shaped pigments are selected from aluminium, iron, steel, brass, copper, silvered copper and nickel.

One advantageous further embodiment of the inventive idea results from the fact that the largest linear dimension of platelet-shaped pigments is between 25 and 50 μm.

One advantageous further embodiment of the inventive idea results from the fact that selected for the second coating on the second, inner surface are second white pigments and fillers that have on average a transmission of more than 50% in the thermal infrared wavelength region of 3 to 50 μm, but at least 5 to 25 μm.

Another advantageous further embodiment of the inventive idea results from the fact that the second white pigments and fillers are selected from zinc sulfide, zinc oxide, from calcium carbonate, from the group of polymer pigments.

One advantageous further embodiment of the inventive idea results from the fact that the reflection on the first, outer surface in the near infrared region rises steeply from 700 nm and at 800 to 1000 nm is more than 60%.

### FIGURES

FIG. 1 is a section through the flat metal structural element, where
1 is the first coating on the first, outer surface
2 is the second coating on the first, outer surface
3 is the first coating on the second, inner surface
4 is the second coating on the second, inner surface
5 is the metal substrate.

FIGS. 2 to 5 are curves of the hemispheric backscatter recorded with a PC plug-in spectrometer made by the company Avantes, with a spectral sensitivity of 320 to 1100 nm to which was attached an Ulbricht sphere for the coating samples described in examples 1 to 4.

The subject of the invention will now be explained in more detail with reference to examples.

### EXAMPLE 1

An anticorrosion coating according to the invention (FIG. 1 (1)) was produced according to the following formulation:
70.00 g Polyester varnish LT COVB MLS made by the company Temme Nuremberg
10.00 g Moly White 212 white anticorrosion pigment, made by the company Brenntag
40.00 g Ferro PK 0032 white pigment made by the company Ferro
02.10 g Geoxyd hardener MEKP 50 S, made by the company Temme Nuremberg
10.00 g Acetone

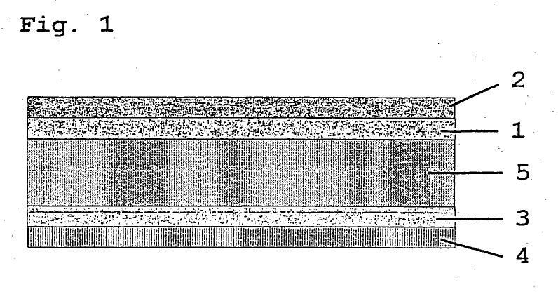

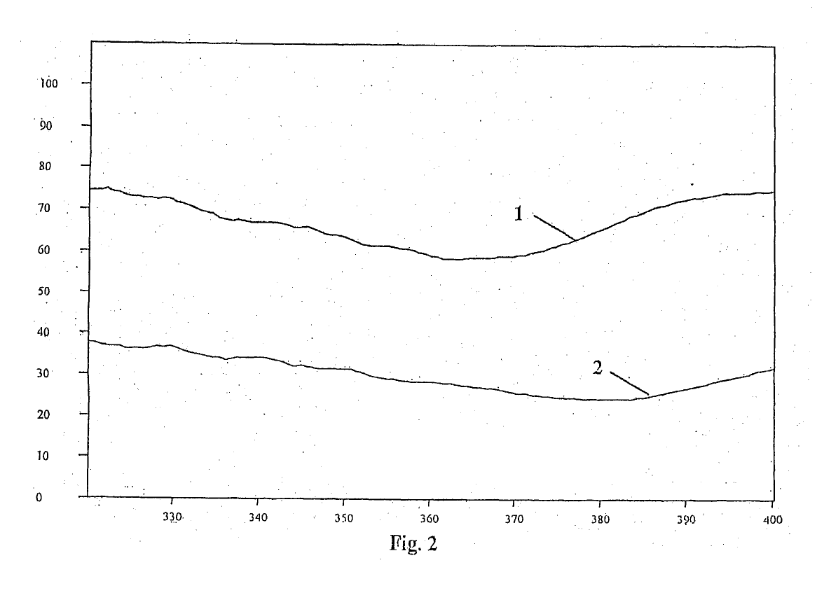

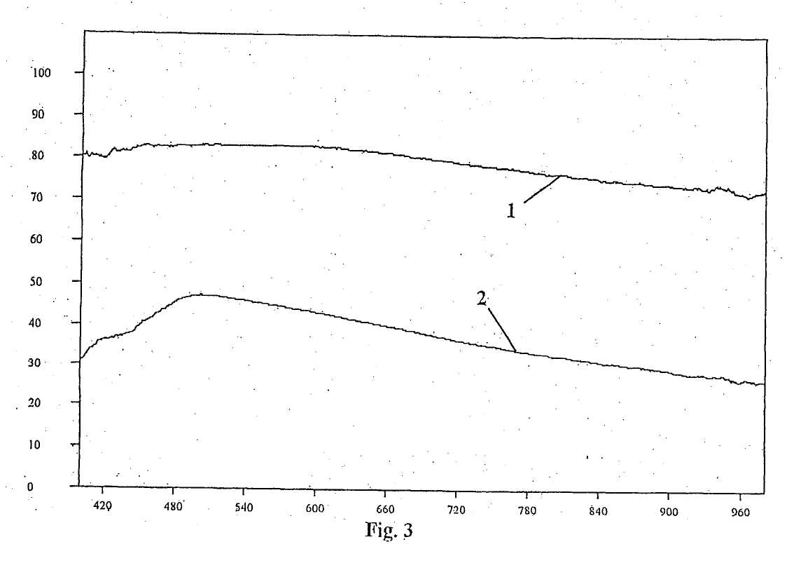

The mixture was applied to a 0.7 mm thick, galvanised steel sheet. After curing, the sheet's coating thickness was approximately 25 μm. The spectral reflection of the coating on the steel sheet was measured in the UV wavelength region of 320 to 400 nm. The results are shown in FIG. 2, curve (1). Curve (2) shows the reflection from a commercially available anticorrosion primer. The reflection in the UV range is much lower. FIG. 3 shows the spectral reflection of the anticorrosion coating according to the invention as curve (1) and that of the commercially available coating as curve (2) in the wavelength region of 400 to 980 nm. In this wavelength region, the reflection of the coating according to the invention is much higher which also means that more sun is being reflected.

### EXAMPLE 2

A dark-red top coat (FIG. 1 (2)) was produced according to the following formulation:
60.00 g Maincote HG-54K, made by the company Rohm+Haas
00.20 g Defoamer Byk 024
00.40 g Pigment dispersing agent N made by the company BASF
10.00 g Blanc Fixe Mikro made by the company Sachtleben
20.00 g Super fine zirconium silicate made by the company Wema Nuremberg
03.00 g Calcium carbonate duramite
02.70 g Black tinting mixture comprising
40.00 g Water
40.00 g Butyl glycol
20.00 g Paliogen Black L0086 BASF
06.20 g Ecopaque True Red 13 327 made by the company Heubach
02.00 g Hostafine Red P2GL made by the company Clariant
00.50 g Thickener Aerosil 380 made by the company Degussa

The dark-red top coat was applied to the surface of a metal plate that had been previously coated with the anticorrosion coating described in example 1. After drying, a coating with a thickness of 30 μm was established.

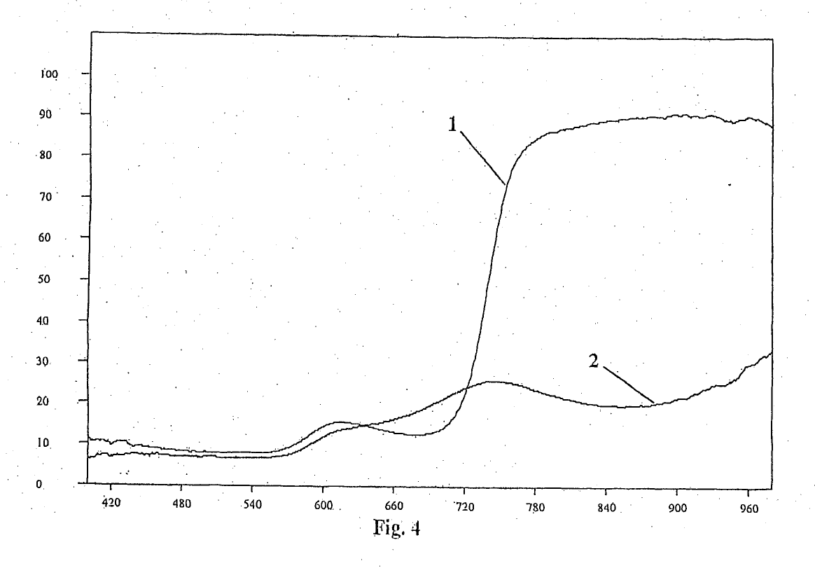

The plate was spectrally measured in the wavelength region 400 to 980 nm. The results of the measurements are shown in FIG. 4. Here, curve (1) represents the spectral reflection of the dark-red top coat and curve (2) the spectral reflection of a commercially available dark-red top coat made by the company Barloworld Coatings, Australia, that was also measured for purposes of comparison. Both plates were placed on a 4-cm thick styropor plate and exposed to solar radiation of 96,000 Lx. The plate coated according to the invention heated up to 48° C. and the plate with the commercially available dark-red paint heated up to 64° C.

### EXAMPLE 3

An anticorrosion primer (FIG. 1 (3) for the underside of the plate was produced according to the following formulation:
70.00 g Polyester varnish LT COVB MLS made by the company Temme Nuremberg
15.00 g Sachtolith HD-S made by the company Sachtleben
12.00 g Zinc Flakes fine grade made by the company Novamet
04.00 g Zinc chromate powder
02.10 g Geoxyd hardener MEKP 50 S, made by the company Temme Nuremberg
10.00 g Acetone

The primer was applied to the rear of the plate described in example 2. In cured condition, the thickness of the anticorrosion coating was 10 μm.

A low-emission coating (FIG. 1 (4)) was produced according to the following formulation:
70.00 g Polyester varnish LT COVB MLS made by the company Temme Nuremberg
25.00 g Sachtolith HD-S made by the company Sachtleben
20.00 g Hydrolux Reflexal 100 aluminium plates made by the company Eckart
02.10 g Geoxyd hardener MEKP 50 S, made by the company Temme Nuremberg
10.00 g Acetone

The coating was applied on the primer from example 3 on the plate described in example 2. The spectral reflection of the coating was measured with a Nicolet Magna 550 IR under an Ulbricht sphere in the wavelength region of 2.5 to 25 μm. The measuring results were compared to a calculated black radiator at room temperature, 293 Kelvin. The emissivity was found to be 0.68.

The plate was placed in a frame together with the reference plate from example 2 so that the underside of the two plates was free and the upper side was exposed to the sun. The underside of the reference plate was coated with a commercially available white interior paint. The two undersides were measured using a contactless radiation thermometer of the type TASCO. At 96,000 Lx solar radiation, the temperature of the reference plate was 62° C. and that of the plate coated according to the invention was 43° C.

### EXAMPLE 4

A grey top coat (FIG. 1 (2)) was produced according to the following formulation:
70.00 g Polyester varnish LT COVB MLS made by the company Temme Nuremberg
60.00 g Ferro PK 0032 white pigment made by the company Ferro
01.00 g Paliogen black L0086 BASF
01.00 g Shepherd blue 3 made by the company Shepherd
01.00 g Ecopaque true red 13 327 made by the company Heubach
02.10 g Geoxyd hardener MEKP 50S made by the company Temme
10.00 g Acetone

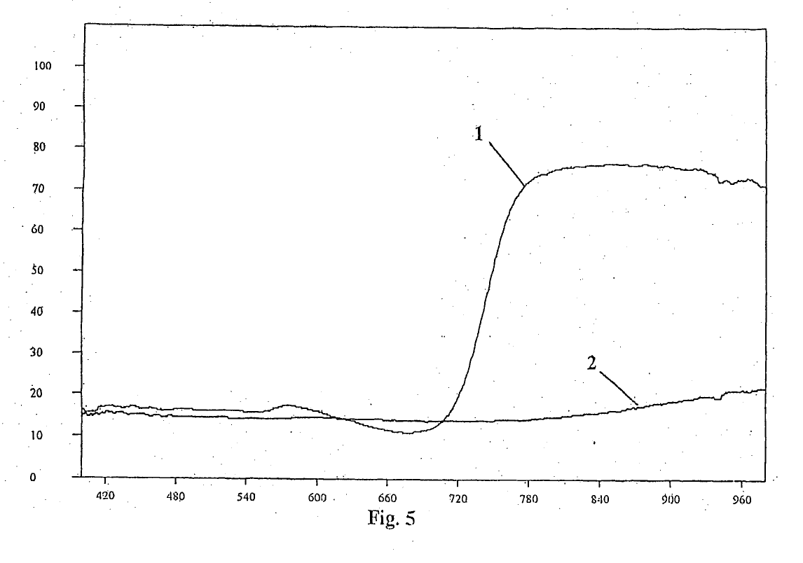

The grey top coat was applied to the anticorrosion coating described in example 1 on a metal plate and after curing measured spectrally in the wavelength region 400 to 980 nm. As a comparison, a metal plate provided with a grey top coat of the type “Charcoal 462” described “reflective” provided by the steel company Dofasco Hamilton, ON, Canada, was measured. The results of the measurements are shown in FIG. 5. Here, curve (1) represents the spectral reflection of the coating according to the invention and curve (2) that of the reference plate.

The rear of the plate coated according to the invention was coated with the anticorrosion primer described in example 3. A low-emission coating produced according to the following formulation was then applied to this primer.
14.00 g Mowilith DM 611 made by the company Hoechst
12.00 g Acronal 296D made by the company BASF
14.00 g Ropaque OP96 made by the company Rohm+Haas
00.20 g Defoamer Byk 024
00.40 g Pigment dispersing agent N BASF
24.00 g Sachtolith L made by the company Sachtleben
12.00 g Water
13.00 g Hydrolux Reflexal 100 made by the company Eckart
04.00 g Butyl glycol

The metal plate coated according to the invention was sent to the measuring institute Bodycote Materials Testing Canada Inc where it was measured in comparison to a metal plate coated with a commercially available grey top coat.

The following values were determined:

| | External | Solar | Internal |
|---|---|---|---|
| Specimen | emissivity | absorption | emissivity |
| Example 4 grey | 0.89 | 0.41 | 0.55 |
| Standard grey | 0.87 | 0.84 | 0.89 |

The plates were exposed to radiation from a solar simulator with a power of 862 W/m².

The heating of the plates was measured in each case with a temperature sensor placed on the plates. The metal plate coated with standard grey heated up to 68.0° C. and the metal plate coated according to the invention heated up to 52.8° C.

1-23. (canceled)

24. Flat metal structural element, characterized in that
a) its first, outer surface is provided with a first coating that protects the metal from corrosion and reflects on average 60% of sunlight in the wavelength region of 320 to 1200 nm
b) its first, outer surface is provided with a second coating that has on average a reflection of less than 60% in the visible light wavelength spectrum of 400 to 700 nm and has on average a reflection of more than 60% in the near infrared wavelength regin of 700 to 1200 nm

25. Flat metal structure element according to claim 24, characterized in that
a) its second, inner surface is provided with a first coating that protects the metal from corrosion
b) its second, inner surface is provided with a second coating that has low emissivity and an emissivity of less than 0.75 in the thermal infrared wavelength region of 5 to 25 μm.

26. Flat metal structure element according to claim 24, characterized in that the first coating on the first, outer surface reflects on average 70% of sunlight in the wavelength region of 320 to 1200 nm.

27. Flat metal structural element according to claim 24, characterized in that second coating on the first, outer surface has on average a reflection of less than 50% in the visible light wavelength spectrum of 400 to 700 nm.

28. Flat metal structural element according to claim 24, characterized in that the second coating on the first, outer surface has on average a reflection of more than 70% in the near infrared wavelength region of 700 to 1200 nm.

29. Flat metal structural element according to claim 24, characterized in that the second coating on the second, inner surface has an emissivity of less than 0.65 in the wavelength region of 5 to 25 μm.

30. Flat metal structural element according to claim 24, characterized in that the binder in the coatings is selected from the group of solvent-based binders comprising acrylates, styrene acrylates, polyvinyls, polystyrenes and styrene copolymers, alkyd resins, saturated and unsaturated polyesters, hydroxyfunctional polyesters, melamine-formaldehyde resins, polyisocyanate resins, polyurethanes, epoxy resins, fluoropolymers and silicones, chlorosulfonated polyethylene, fluorinated polymers, fluorinated acryl copolymer, fluorosilicones, plastisols, PVDF and mixtures therof, selected from the group of aqueous binders comprising the group of water-soluble binders comprising alkyds, polyesters, polyacrylates, epoxides and epoxide esters, from the group of aqueous dispersions and emulsions comprising dispersions and emulsions based on acrylate, styrene acrylate, ethylene acrylic acid copolymers, methacrylate, vinyl pyrrolidone vinyl acetate copolymers, polyvinyl pyrrolidone, polyisopropyl acrylate, polyurethanes, silicone, wax dispersions based on polyethylene, polypropylene, Teflon®, synthetic waxes, fluorinated polymers, fluorinated acryl copolymer in aqueous solution, fluorosilicones and mixtures thereof.

31. Flat metal structural element according to claim 24 characterized in that anticorrosion pigments are selected for the first coating on the first outer surface that are transparent in the solar wavelength region of 400 to 1200 nm and that their particle size is selected so that they have on average a backscatter of more than 60% in the solar wavelength region of 320 to 1200 nm.

32. Flat metal structural element according to claim 24 characterized in that the anticorrosion pigments are selected from the group of white anticorrosion pigments, in particular selected from calcium zinc molybdate compounds, selected from strontium-zinc-phosphorosilicate.

33. Flat metal structural element according to claim 24 characterised in that the particle size of the white anticorrosion pigments is between 1 and 3 μm.

34. Flat metal structural element according to claim 24 characterized in that first white pigments and fillers for the first coating on the first, outer surface are selected from the group of inorganic white pigments and fillers, selected from the group of metal oxides, in particular zirconium oxide, selected from the group of metal sulfates, metal sulfides, metal fluorides, metal silicates, metal carbonates and mixtures thereof.

35. Flat metal structural element according to claim 34, characterized in that the first white pigments and fillers are selected from the group of degradable materials, selected from calcium carbonate, magnesium carbonate, zirconium silicate, aluminum oxide, barium sulfate and mixtures thereof.

36. Flat metal structural element according to claim 24, characterized in that first colored pigments for the second coating on the first, outer surface are selected from the group of organic pigments that absorb spectrally selectively in the visible light wavelength spectrum of 400 to 700 nm and have on average a transmission of more than 60% in the near infrared wavelength region of 700 to 1200 nm.

37. Flat metal structural element according to claim 36, characterized in that the first colored pigments have on average a transmission of more than 70% in the near infrared wavelength region of 700 to 1200 nm.

38. Flat metal structural element according to claim 36, characterized in that the fir colored pigments are selected from the group of azo pigments, selected from monoazo, bis-azo, 3-naphthol, naphthol AS, lacquer-formed azo, benzimidazolone, bis-azo condensation, metal complex, isoindolinone and isoindoline pigments, selected from the group of polycyclic pigments, selected from phthalocyanine, quinacridone, perylene and perinone, thioindigo, anthraquinone, anthrapyrimidine, flavanthrone, pyranthrone, anthanthrone, dioxazine, triarylcarbonium, quinophthalone and diketo-pyrrolopyrrole pigments.

39. Flat metal structural element according to claim 24 characterized in that second colored pigments for the second coating on the first, outer surface are elected from the group of inorganic pigments which absorb spectrally selectively in the visible light wavelength spectrum of 400 to 700 nm and have on average a reflection of more than 50% in the near infrared wavelength region of 700 to 1200 nm.

40. Flat metal structural element according to claim 39, characterized in that the second inorganic colored pigments have on average a reflection of more than 60% in the near infrared wavelength region of 700 to 1200 nm.

41. Flat metal structural element according to claim 39 characterized in that the second inorganic colored pigments are selected from the group of metaloxides and hydroxides, in particular iron oxides, form cadmium, bismuth, chromium, ultramarine blue and iron-blue pigments, from the group of mixed phase rutile and spinel pigments and coated, platelet-shaped mica pigments.

42. Flat metal structural element according to claim 25 characterized in that selected for the second coating on the second, inner surface are platelet-shaped metal pigments that have on average a reflection of 60% in the thermal infrared wavelength region of 3 to 50 μm.

43. Flat metal structural element according to claim 42 characterized in that the platelet-shaped pigments are selected from aluminum, iron, steel, brass, copper, silvered copper and nickel.

44. Flat metal structural element according to claim 42, characterized in that the largest linear dimension of the platelet-shaped pigments is between 25 and 50 μm.

45. Flat metal structural element according to claim 25, characterized in that selected for the second coating on the second, inner surface are second white pigments and fillers that have on average a transmission of more than 50% in the thermal infrared wavelength region of 3 to 50 μm, but at least 5 to 25 μm.

46. Flat metal structural element according to claim 45 characterized in that the second white pigments and fillers are selected from zinc sulfide, zinc, oxide, form calcium carbonate, from the group of polymer pigments.

47. Flat metal structural element according to claim 24, characterized in that the reflection on the first, outer surface in the near infrared region rises steeply from 700 nm and at 800 to 1000 nm is more than 60%.
